(19) United States
(12) Patent Application Publication
(10) Pub. No.: US 2014/0078407 A1
(43) Pub. Date: Mar. 20, 2014

(54) TRANSPARENT ELECTRONIC IMAGE DISPLAY APPARATUS FOR REFRIGERATED MERCHANDISERS AND THE LIKE

(71) Applicant: Planar Systems, Inc., Beaverton, OR (US)

(72) Inventors: Patrick J. Green, Beaverton, OR (US); Benjamin Robert Clifton, Oregon City, OR (US); Kurt R. Munson, Tigard, OR (US); Allen R. Gard, Portland, OR (US); Adiel Abileah, Portland, OR (US); Cris Derr, Aloha, OR (US); Adam R. Aschenbach, Beaverton, OR (US)

(73) Assignee: Planar Systems, Inc., Beaverton, OR (US)

(21) Appl. No.: 13/785,870

(22) Filed: Mar. 5, 2013

Related U.S. Application Data
(60) Provisional application No. 61/607,521, filed on Mar. 6, 2012.

(51) Int. Cl. H04N 5/64

(52) U.S. Cl. CPC H04N 5/64
USPC 348/836

(57) ABSTRACT

In one embodiment, an electronic display apparatus for installation on a display case merchandiser having a door with a transparent front panel is disclosed. The apparatus comprises a bezel, a transparent electronic image display panel, and a light source. The bezel is configured to attach to the door of the merchandiser so a portion of the transparent front panel of the door is viewable through an opening of the bezel. The display overlays at least a portion of the bezel opening and a portion of the transparent front panel of the door when the apparatus is installed. The light source fits in a gap formed between the bezel and the door when the apparatus is installed.

### RELATED APPLICATIONS

This application claims the benefit under 35 U.S.C. §119(e) of U.S. Provisional Patent Application No. 61/607,521, filed Mar. 6, 2012, and titled “Transparent Electronic Image Display Apparatus for Refrigerated Merchandisers and the Like”, which is incorporated herein by reference.

### TECHNICAL FIELD

The field of this disclosure relates to merchandisers including a transparent door or panel, such as a glass door refrigerated merchandiser, and particularly to transparent electronic image display devices for use with such merchandisers which enable images and/or video to be superimposed on the transparent door or panel and to allow contents of the merchandiser to be viewed through the transparent display device.

### BACKGROUND

One of the more common styles of refrigerated merchandiser is a refrigerator or freezer unit including an insulated cabinet and a glass front door hinged to the cabinet for allowing a customer access to contents of the cabinet. This type of refrigerated insulated merchandiser is commonly employed for merchandising perishable foods and cold drinks at supermarkets, convenience stores, restaurants, health clubs, and various other retail and commercial establishments. One example of a commercially available refrigerated merchandiser unit is the Model GDM-10 refrigerated glass door merchandiser sold by True Manufacturing Company of O'Fallon, Mo., USA. Other styles of commercially available merchandising display cases include sliding door refrigerated merchandisers, glass-front display cases, and heated merchandisers.

The glass door of a refrigerated merchandiser allows the consumer to view the contents of the cabinet before making a selection. It is well known to place signage on the inside or outside of the glass door, for example as advertising or to provide pricing information. However, such signage is generally static and tends to block the customer's view of the refrigerated contents.

A need exists for a more dynamic eye-catching means of displaying advertising and other promotional images and textual information in connection with a refrigerated merchandiser and other types of display cases.

### SUMMARY

A transparent electronic image display apparatus is disclosed for use with a display case merchandiser such as a glass door refrigerated merchandiser of the kind including a compartment for housing items for display or purchase, and a transparent front panel such as a swing door with an insulated glass panel. The apparatus may include a transparent light-modulating display screen such as a transparent active matrix liquid crystal display (AMLCD) or electrowetting display (passive or active matrix type) secured to the outside of the merchandiser door. In one embodiment, the apparatus may be connected to the door and overlaid or juxtaposed over the transparent front panel of the merchandiser. The apparatus includes a light source (or several light sources) positioned outside of the compartment and oriented to direct light into the compartment through the transparent front panel such that the light is reflected out of the compartment and outwardly through the transparent electronic image display panel.

The transparent electronic image display apparatus may be designed for retrofitting existing merchandiser units in the field. In one embodiment, the apparatus includes a transparent electronic image display connected to a bezel. The bezel can be attached to the outside of an existing merchandiser door with an insulated glass panel. A light source may be attached along an interior surface of the bezel for positioning in a gap formed between the bezel and the outer surface of the insulated glass door of the refrigerated merchandiser when the apparatus is installed. In this manner, the light source may direct illumination inwardly within the merchandiser through the insulated glass panel of the door to illuminate the contents of the merchandiser and, via illumination reflected from surfaces within the merchandiser, to illuminate images displayed on the electronic display screen. The light source may generate heat and so positioning the light source outside of the insulated glass door of the merchandiser may reduce the burden on the merchandiser's refrigeration unit. The light source may be dimmed or temporarily turned off when the merchandiser door is opened, to thereby reduce or eliminate glare in the eyes of the customer.

Additional aspects and advantages will be apparent from the following detailed description of preferred embodiments, which proceeds with reference to the accompanying drawings.

### BRIEF DESCRIPTION OF THE DRAWINGS

FIG. 1 schematically shows a refrigerated glass door merchandiser with a transparent image display screen in its inactive state, so that no image is displayed on the screen and contents of the merchandiser are visible through the display screen;

FIG. 2 shows the refrigerated merchandiser of FIG. 1 with the transparent image display screen displaying images of product advertising and contents of the merchandiser visible through the image display screen;

FIG. 3 is a partial schematic cross section view taken horizontally through a refrigerated glass door merchandiser showing details of a transparent electronic image display apparatus, including a mounting bezel and lighting device in accordance with one embodiment;

FIG. 3A is a partial schematic cross section view of the merchandiser and display apparatus of FIG. 3, showing details of a light source of the display apparatus;

FIG. 3B is a partial schematic cross section view of a variant of the refrigerated merchandiser of FIG. 3 including an illumination subsystem according to a second embodiment;

FIGS. 4 and 5 are respective front and left side elevation views of a transparent electronic image display apparatus according to a third embodiment, attached to a glass door of a refrigerated merchandiser;

FIG. 6. is a cross section view of the apparatus of FIG. 4 taken along a vertical centerline 6-6 illustrated in FIG. 2;

FIG. 7 is a cross section view of the apparatus of FIG. 4 taken along horizontal line 7-7;

FIG. 8 is an oblique view of an interior side of the transparent image display apparatus of FIGS. 4-7 with the door of the refrigerated merchandiser omitted to show details of the apparatus; and

FIG. 9 is an enlarged cross section view of a top portion of the apparatus of FIG. 6 showing detail of an illumination subsystem of the apparatus.

FIG. 10 schematically shows an example merchandiser with another embodiment of a transparent electronic image display apparatus.

### DETAILED DESCRIPTION OF PREFERRED EMBODIMENTS

Digital signage, where traditional printed paper or plastic advertising are replaced with a flat panel display, is one of the fastest growing applications for electronic display technology. The ability to replace a static sign with a colorful, dynamic video or image display provides an eye-catching medium for advertisements and other messaging. While a single sheet of paper or plastic can show only one image, in the same space a programmable flat panel can display a near infinite variety of content, limited only by the output of its video controller and the imagination of the subject matter creator. This content can be a static image, essentially a slide show, or even more engaging video imagery.

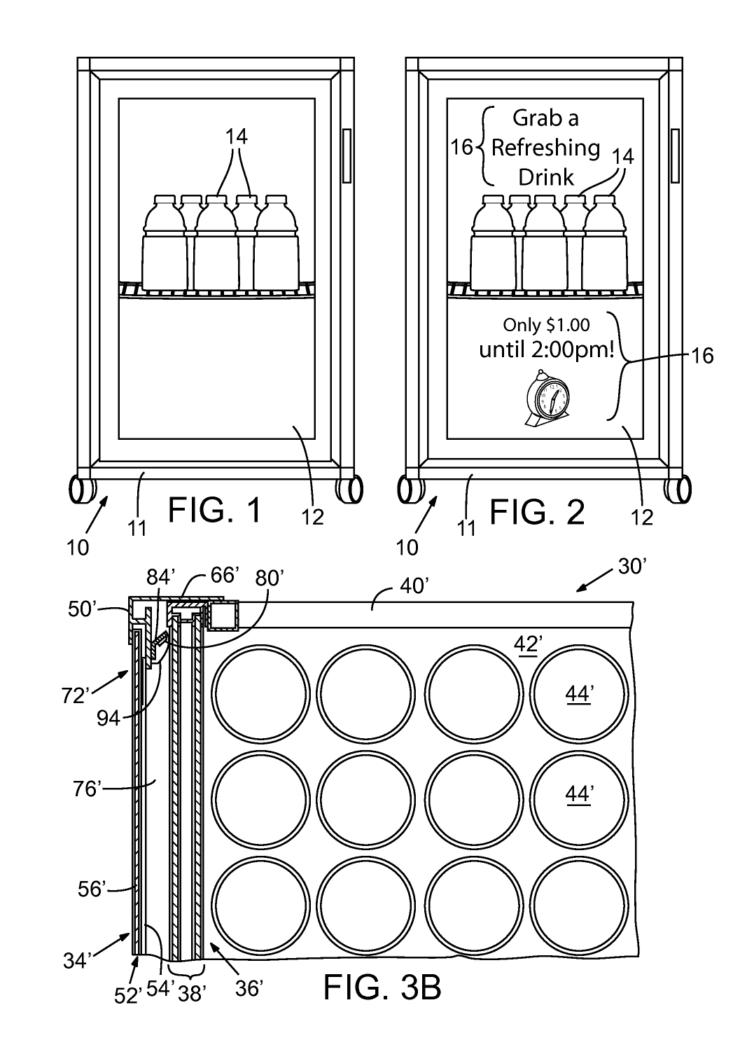

The present inventors recognize that transparent electronic image display technology can offer an opportunity to present the same sort of advertising or messaging used in conventional digital signage while at the same time showing a sample of the product being marketed. FIG. 1 schematically shows a refrigerated merchandiser 10 with a door 11 that includes transparent electronic image display screen 12 shown in its inactive state, so that no image is displayed on display screen 12 and contents 14 of the merchandiser 10 are visible through the transparent display screen 12. FIG. 2 shows the same refrigerated merchandiser 10 with its display screen 12 in an active state, displaying images of product advertising 16 and contents 14 of the merchandiser visible through the image display screen. That is, display screen 12 displays images 16 while revealing contents 14 located within refrigerated merchandiser 10. Display screen 12 may be included with refrigerated merchandiser 10 as original equipment or may be retrofitted to refrigerated merchandiser 10 (e.g., as a field retrofit). Display screen 12 may be driven by a computer or other image source (not shown) connected to display screen 12 via a cable or via wireless communication device, such as BLUETOOTH™, Wi-Fi, or other radio frequency communication technology. In the example illustrated, the images of product advertising 16 are in the form of an animated slide presentation created in Microsoft PowerPoint™.

Glass front refrigerators and freezers make use of double or triple pane tempered insulated glass units (IGUs) in their doors which are filled with an insulating gas and sealed to minimize heat transfer therethrough while allowing visibility of chilled products inside the unit. The present inventors have recognized the desirability of adapting a transmissive display to an existing refrigerator or freezer door without modifying or disturbing glass spacers or edge seals of the IGU.

FIG. 3 is a partial schematic horizontal cross section view of a refrigerated glass door merchandiser 30 according to another embodiment, showing details of a transparent electronic image display apparatus 34 mounted to the outside of a swinging door 36 of the merchandiser 30. Door 36 includes a sealed double-pane IGU 38 filled with an insulating gas such as argon and held in a door frame 70 that is hinged to a sidewall 40 of an insulated cabinet 42 of merchandiser 30 (illustrated as containing rows of soft drink containers 44). Display apparatus 34 includes a mounting bezel 50 for installing display apparatus 34 on the outside of door 36 of merchandiser 30.

Mounting bezel 50 supports a transparent electronic image display panel such as an AMLCD screen assembly 52 including an AMLCD panel 54 optically bonded to an interior surface of a protective cover glass 56 or other transparent material such as plastic. AMLCD panel 54 is preferably a vertical alignment type LCD display, or any other preferred wide viewing angle LC technology, including clear front and rear polarizer layers that do not have anti-glare treatment. An exterior surface 58 of the cover glass 56 may include an anti-reflection (AR) coating to inhibit reflections of room lighting and promote visibility of images displayed on AMLCD panel 54 and of the merchandise or other contents 44 of merchandiser 30. AR coatings or films may be applied to outermost surfaces of each of the panes of glass of IGU 38 to improve light transmission. In some embodiments, all four surfaces of a double pane IGU may be coated with an AR coating during manufacture.

Bezel 50 includes a front frame portion 62 defining an opening covered by AMLCD screen assembly 52, which is adhesively bonded to an inner major surface 64 of front frame portion 62 using a lap joint around the perimeter of the cover glass 56. Inner major surface 64 of front frame portion 62 faces the outer face of door 36 when bezel 50 is installed on door 36. AMLCD screen assembly 52 overlays at least a portion of the bezel opening and a portion of IGU 38 when the display apparatus 34 is installed on door 36. In this manner, a customer may look into a compartment of merchandiser 30 through the AMLCD screen assembly 52 and IGU 38. Front frame portion 62 preferably hides display electronics (not shown), which are connected to an edge or marginal region of AMLCD panel 54, and electronic wiring coupled thereto.

A flange portion 66 of bezel 50 extends rearwardly from front frame portion 62 and AMLCD screen assembly 52 to fit around a periphery of door frame 70. Flange portion 66 of bezel 50 is fastened to the edge of door frame 70 via screws or other fasteners. The wiring that is coupled to AMLCD panel 54 for delivering display-driving signals and electrical power to the display panel is routed through an opening (not shown) in bezel 50 and coupled to an image source external to the display apparatus 34.

Because AMLCD panel 54 is a non-emissive light-modulating display, it requires some sort of rear illumination to be perceived by the viewer. AMLCD screen assembly 52 will typically have a maximum light transmission of only about 5%, so rear illumination intensity must be roughly twenty times the desired luminance of the image to be displayed. In conventional AMLCDs this level of illumination is accomplished using a backlight employing fluorescent bulbs or LEDs arrayed directly behind the AMLCD panel or positioned to edge-illuminate a light guide that directs light behind the AMLCD. Neither of these lighting schemes is suitable for use in a transparent display since both approaches in their standard implementations interfere with the desired clear optical path between the viewer and the product presented behind the display.

To provide the desired illumination of both the AMLCD panel 54 and contents 44, display apparatus 34 includes an illumination subsystem 72 located in a gap 76 formed between IGU 38 of door 36 and AMLCD screen assembly 52. Gap 76 may be sized in the range of approximately 0.25 inches to 3 or 4 inches to accommodate illumination subsystem 72 and provide a venting passageway. Illumination subsystem 72 comprises a light source in the form of one or more arrays or rows of white light LEDs 80. For example, the light source may extend along a periphery of the opening of bezel 50. In a preferred embodiment, LEDs 80 border all four edges of AMLCD panel 54 and are arranged to direct illumination inwardly into merchandiser 30 through the double-pane glass (IGU 38) of door 36. LEDs 80 may be mounted to a backplate 84 that serves as a heat sink for LEDs 80 and that is coupled to bezel 50 to provide a thermally conductive pathway between LEDs 80 and bezel 50 for dissipating heat generated by LEDs 80. Backplate 84 may be painted white and include a light baffle portion 88 to help direct illumination inwardly toward a concave reflector 90 located inside door 36 along sidewalls 40, which reflects illumination from LEDs 80 both toward contents 44 of merchandiser and diffusively back toward AMLCD screen assembly 52. To optimize illumination uniformity and minimize shadowing of the AMLCD panel 54 by merchandise or other contents 44 within the refrigeration chamber, the LEDs 80 are desirably located laterally as close as possible to the edge of the active area of transparent AMLCD panel 54, and surrounding the AMLCD panel 54 in a 360° fashion. In some embodiments, LEDs may be spaced approximately 0 to 2 inches from AMLCD panel 54 in a direction perpendicular to the plane of AMLCD panel 54. Baffle portion 88 may be attached to bezel 50 and disposed between the bezel opening and LEDs 80 to occlude a direct view of LEDs 80 through AMLCD panel 54. In an alternative embodiment, baffle portion 88 may be attached directly to the door 36 and disposed between the periphery of the bezel opening and the LEDs 80.

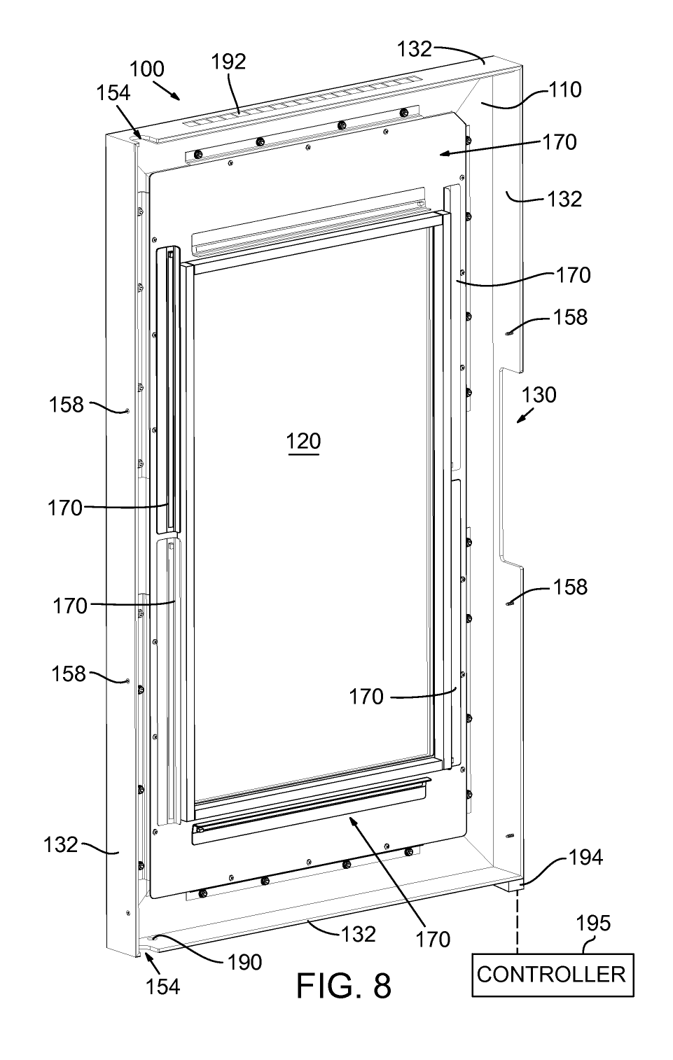

In one embodiment, each of the untreated glass surfaces of IGU 38 will reflect approximately 4% of light incident at each air-glass interface (−96% light transmission). With four such interfaces the total transmission is approximately 0.96⁴ or about 85%. Thus, approximately 15% of light entering the door is reflected. Light entering the compartment of merchandiser 30 is attenuated by an additional 15% when exiting. Consequently, the total light transmission from LEDs 80 is approximately 0.96⁸ or approximately 72%. To compensate for these losses and achieve the desired level of illumination for display apparatus 34, an average power of approximately 120 watts may be applied to LEDs 80. Placing LEDs 80 within gap 76 may reduce the burden on the refrigeration unit of merchandiser 30 due to heat generated by LEDs 80. A top section of bezel 50 may optionally include vent holes 192 (FIG. 8) extending through bezel 50 to help convectively vent from gap 76 at least some of the heat generated by LEDs 80. In other embodiments, LEDs or other light sources may be provided within the cabinet of merchandiser 30 rearward of door 36 and may direct illumination at both the contents of merchandiser 30 and the display apparatus 34.

FIG. 3A is a schematic partial horizontal cross section view of the merchandiser 30 and display apparatus 34 of FIG. 3, according to one embodiment. For purposes of illustration, the dimensions of FIG. 3A are not to scale. LEDs 80 emit a beam of light 21 with an optical dispersion angle 20 of approximately 120°. To improve efficiency and illumination uniformity, a center 22 of the beam of light 21 from LEDs 80 (i.e., the axis of light beam 21) is directed inward, through transparent panel 38, into compartment 42 of merchandiser 30 with an angle of incidence 24 approximately 45° from the plane 26 of transparent panel 38. In other embodiments, angle of incidence 24 may be varied, particularly if optical dispersion angle 20 of the specific LED employed is larger or smaller. For example, LEDs 80 may have a larger or smaller optical dispersion angle 20 ranging between 60° and 180°. The angle of incidence 24 may be larger or smaller than 45°, for example in the range of −20° to +90°, or between 15° and 60°, or between 0° and 90°, or between 5° and 80°.

FIG. 3B illustrates a variant of the merchandiser 30 and display apparatus 34 of FIG. 3, according to another embodiment. In FIG. 3B, reference numerals 30′, 34′, 38′ etc. correspond to the elements of FIG. 3 identified by reference numerals without the prime (e.g. 30, 34, 38). With reference to FIG. 3B, a diffuser 94 is provided over LEDs 80′ to eliminate or reduce artifacts of “hot spots” of illumination caused by the intense localized emission from individual LEDs 80′. Diffuser 94 is made of a suitable optical diffuser material, such as holographic and other micropatterned optical diffuser material fabricated from PET or similar polymeric materials. In some embodiments, diffuser 94 may be in optical contact with IGU 38′. Diffuser 94 may be attached to bezel 50′ and disposed over LEDs 80′. As one example, diffuser 94 may be made of a flexible film and arranged as a shroud along the length of a row of LEDs 80′, spaced apart and wrapping around LEDs 80′ to form a duct or chimney, as indicated in FIG. 3B, for ventilation of heat generated by LEDs 80′ and directing it away from door 36′ of merchandiser 30′. In another example, diffuser 94 may be elongate and extend at least partially around LEDs 80′ so as to form a duct between diffuser 94 and bezel 50′. Thus, air heated by LEDs 80′ may be routed away from door 36′ and vented out of vent holes 192 (FIG. 8). The heated air may flow via natural convection or via a fan placed within the duct, for example. In this manner, the air within the gap between AMLCD panel 54′ and door 36′ is in fluid communication with ambient air outside of merchandiser 30′ via vent holes 192 (FIG. 8).

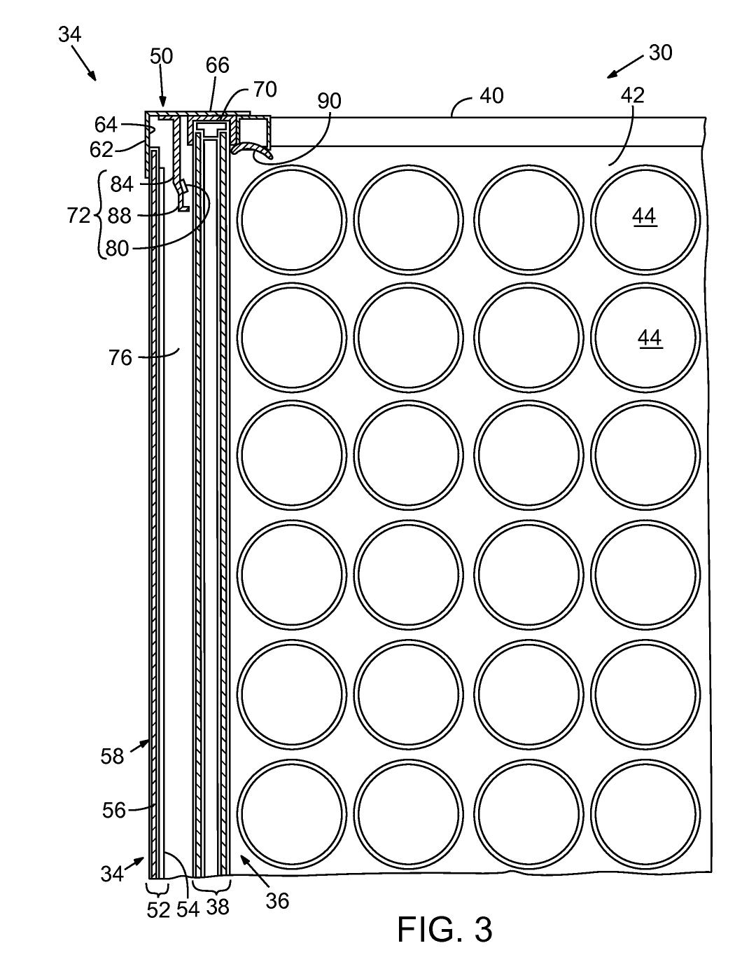

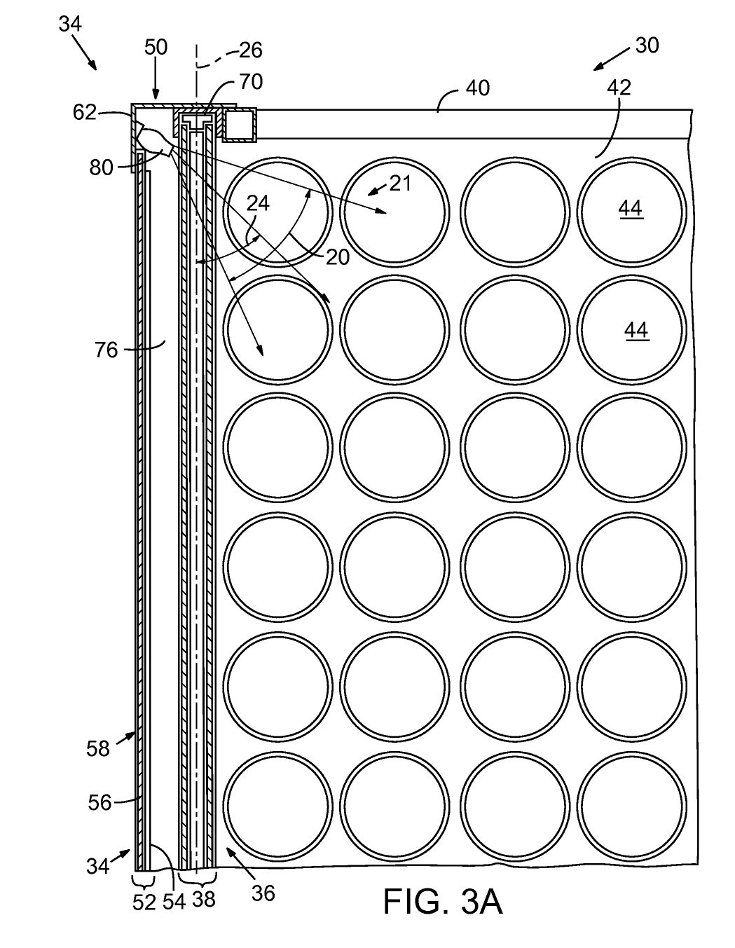

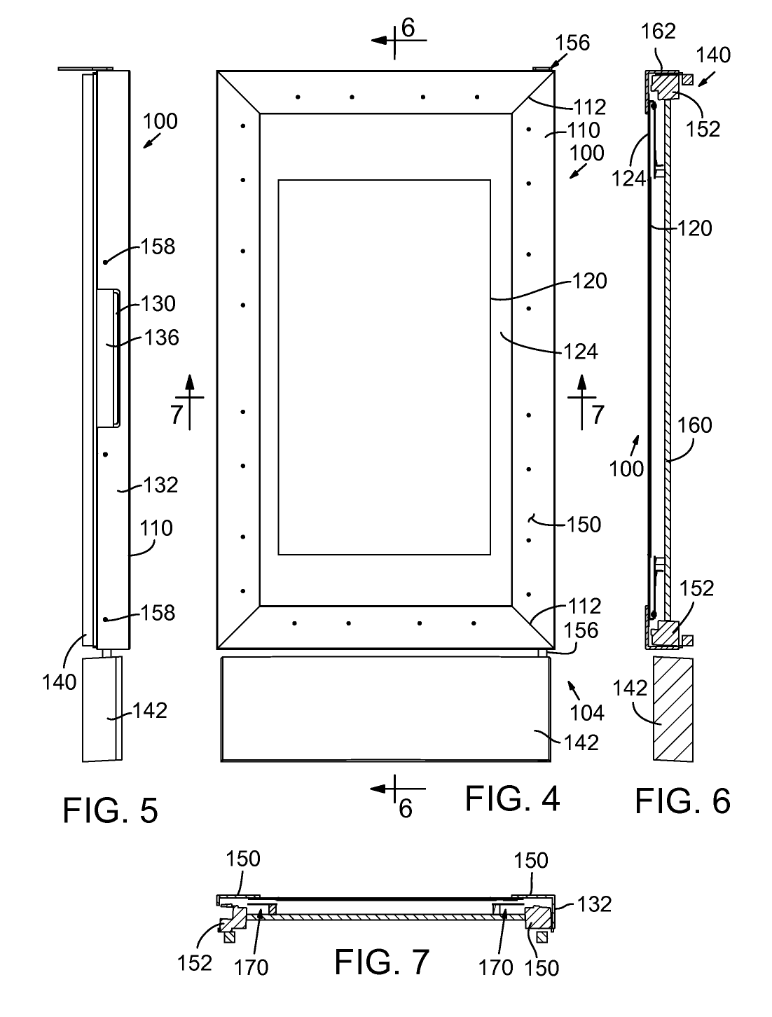

FIGS. 4-7 illustrate a transparent electronic image display apparatus 100 according to still another embodiment. FIG. 4 is a front elevation view of apparatus 100 installed on a merchandiser 104, and illustrates a bezel 110 comprised of four sections of the bezel 110 joined at their ends via miter joints 112 to form corners of the bezel 110. In the illustrated embodiment, an AMLCD display panel 120 bonded to cover glass 124 comprises only a portion of the total area of cover glass 124, leaving a margin for other components of apparatus 100 as discussed below. Cover glass 124 is adhesively secured to bezel 110 in the same manner as discussed above with reference to FIG. 3. Turning now to FIG. 5, which is a left side elevation of apparatus 100, a handle opening 130 (see also FIG. 8) is provided in a flange portion 132 of bezel 110 to allow manual access to a handle 136 of a door 140 of the merchandiser for opening the door 140 to access products contained in the merchandiser (only a door 140 and a pedestal vent cover 142 of the merchandiser are illustrated in FIGS. 4-6; the cabinet, contents, and refrigeration unit of the merchandiser are omitted for clarity).

As with the embodiment illustrated in FIG. 3, flange portions 132 of apparatus 100 shown in FIGS. 4-7 extend rearwardly from the plane of a front frame portion 150 to bracket and abut left, right, top, and bottom outer edges of a peripheral frame 152 of door 140. Notches 154 (FIG. 8) are in upper and lower flange portions 132 of bezel 110 for providing clearance for hinge pins 156 of door 140. Screws 158 are driven through left and right flange portions 132 and into peripheral frame 152 to secure apparatus 100 to door 140 without penetrating and compromising edge seals of an IGU 160 of door 140. Bezel 110 is preferably formed of four sections of bent sheet metal and sized to closely fit around a door 140 to prevent dirt and debris from entering into a gap 172 between cover glass 124 and IGU 160, and to enable display apparatus 100 to be installed without modifying door 140. Preferably apparatus 100 may be retrofitted on an existing merchandiser 104 in the field without the use of special tools or equipment and without compromising the performance or efficiency of refrigerated merchandiser 104. A strip of VELCRO™ or other brand of hook-and-loop fastener material 162 may be adhered along an inside surface of a top section of flange 132 to facilitate holding apparatus 100 in place on door 140 during installation in the field via attachment to a mating strip of the hook-and-loop fastener material that is adhered to a top surface of the door frame 152 during installation. In another embodiment (not shown), bezel 110 is pivotably secured to one edge of door 140 by a hinge and to the opposite edge of door 140 by a locking mechanism (instead of by screws 158), to facilitate cleaning of a rear side of display panel 120.

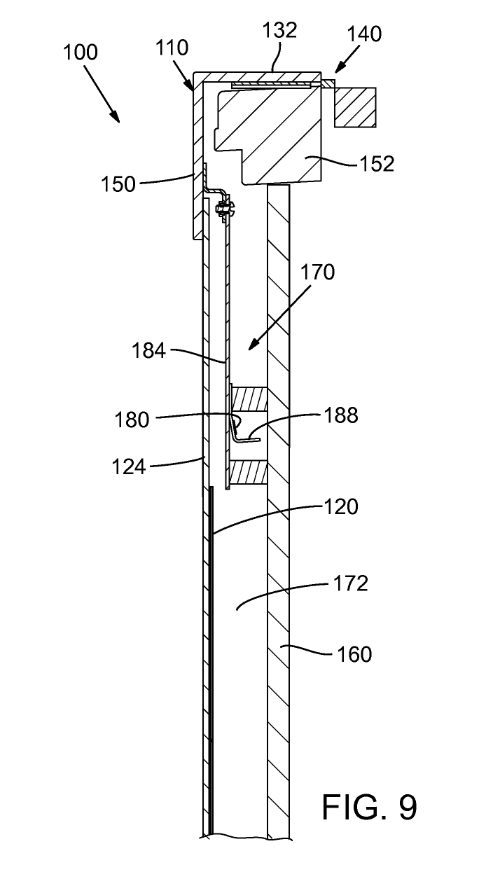

With reference to FIGS. 6-8, display apparatus 100 further includes multiple illumination subassemblies 170 attached to an interior side of bezel 110 in a manner similar to the description above with reference to FIG. 3 and interposed in the gap 172 formed between cover glass 124 and IGU 160. FIG. 9 is an enlarged detail section view of a top portion of apparatus 100 showing detail of one of the illumination subassemblies 170. With reference to FIG. 9, each illumination subassembly 170 includes a row of white light LEDs 180, which in some embodiments may be optically contacting or optically bonded to the outer pane of IGU 160, for example by applying an index matched silicone material therebetween during installation, to thereby improve light transmission through IGU 160. LEDs are mounted on a backplate 184 that is coupled to bezel 110 to thereby provide a heat sink and thermal pathway for dissipating heat generated by LEDs 180. A baffle 188 is positioned adjacent LEDs 180 for shielding illumination from shining directly into the customer's eyes through transparent AMLCD display assembly 120. Wiring (not illustrated) for AMLCD display panel 120 and illumination subassemblies may exit bezel 110 through a hole 190 (FIG. 8) located in the lower flange 132 near the door hinge and to a controlling computer or other source of driving signals and power.

In one embodiment, illumination subassemblies 170 are driven by a power supply (not shown) coupled to a controller 195 (FIG. 8) that is configured to adjust the brightness of the LEDs when a change in the position of the merchandiser door is detected. For example, the LEDs may be dimmed in response to door 140 being opened, thereby preventing customers from viewing the direct high-intensity illumination produced by the LEDs. A switch or sensor such as a proximity switch 194 (FIG. 8) may be provided between the door and the cabinet for this purpose, or in another location, and coupled to the power supply control system to detect when the door 140 is open. Switch 194 may be a hall effect, optical, or other suitable switch connected wirelessly or via a wire to the control system.

In some embodiments, the display panel (54/56, 54′/56′, 120/124) may comprise a touch screen interface for interacting with the images or video displayed on AMLCD display screen (54,54′, 120). Non-limiting examples of suitable touch input technology include projected capacitance, IR, and optical touch input systems. In one embodiment using projected capacitance, the protective cover glass (56, 56′, 124) is replaced with the projected capacitive substrate glass and is optically adhered to the AMLCD panel (54, 54′, 120) and mounted directly to bezel (50, 50′, 110) via a lap joint. For an implementation of touch input using an IR or optical touch transducer design, the protective glass (56, 56′, 124) may be retained and the emitter and detector hardware (not shown) may be located in a perimeter space created between the bezel (50, 50′, 110) and the protective glass (56, 124).

For ease of illustration, the embodiments described above generally relate to a transparent electronic image display apparatus occupying or overlying substantially all of a transparent portion (e.g., a glass portion) of a door for a merchandiser. In some embodiments, a transparent electronic image display apparatus may be mounted to a door for a merchandiser so that only a portion of the door is occupied by the display apparatus. Put another way, in some embodiments, one or more regions of a door may be left uncovered by a transparent electronic image display apparatus fitted to the door.

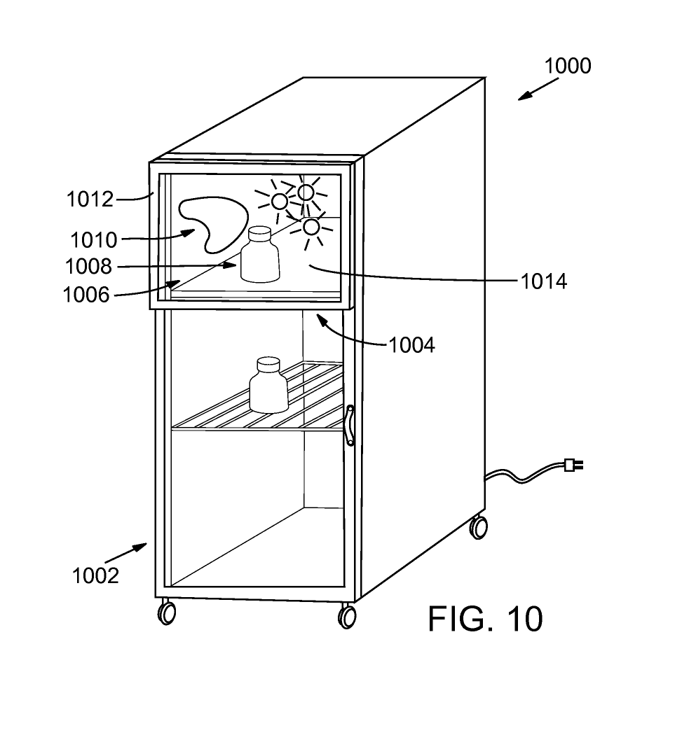

As an example, FIG. 10 schematically shows an embodiment of a merchandiser 1000 including a door 1002, a portion of which is fitted with a transparent electronic image display screen 1004. Transparent electronic image display screen 1004 overlays an illuminated showcase region 1006 of the merchandise compartment included in merchandiser 1000. In the example shown in FIG. 10, transparent electronic image display screen 1004 is depicted in an active state, displaying images 1010 (e.g., product advertising) while revealing contents 1008 visible through the screen behind a transparent panel of door 1002 within the merchandise compartment.

Transparent electronic image display screen 1004 includes a bezel 1012, a portion of which crosses the transparent panel of door 1002. In some embodiments, the portion of bezel 1012 crossing door 1002 may act as a light barrier to prevent light leakage where bezel 1012 crosses the transparent panel. For example, a light-blocking structure included in, attached to, or extending from bezel 1012 may fill a gap between door 1002 and bezel 1012 to prevent light leakage from an illuminated showcase region 1006 toward the ambient environment and/or other regions of merchandiser 1000 (e.g., portions below shelf 1014). Additionally, in some embodiments, a portion of bezel 1012 crossing door 1002 may include a reflective interior surface that reflects or redirects light toward illuminated showcase region 1006.

In some embodiments, merchandiser 1000 may include an opaque light partition that forms a boundary between illuminated showcase region 1006 and another portion of the merchandiser compartment. In the example shown in FIG. 10, opaque light partition 1014 is depicted as a shelf. Including a light partition may prevent light leakage from illuminated showcase region 1006 to another portion of the compartment. In some embodiments, bezel 1012 may cross a portion of the transparent panel of door 1002 at a location aligned with one edge of the light partition. In some embodiments, a light partition may include one or more reflective surfaces positioned to redirect light back toward an interior region of illuminated showcase region 1006.

In other embodiments (not illustrated) the transparent electronic image display panel (34, 34′, 120/124) may implement an electronic image display technology other than AMLCD; for example, a transparent electrowetting display, a transflective display, or an emissive transparent display, such as an EL display or a transmissive organic light emitting diode (T-OLED) display. In the case of an EL or T-OLED display, which do not require backlighting, the illumination subsystems (72, 72′, 170) may be omitted and the display may be bonded directly to the glass of the merchandiser door. In some of such embodiments, a separate merchandise illumination subsystem may be included elsewhere to light or brighten the appearance of items within a merchandiser. In some embodiments, an EL display or T-OLED display may be formed on a flexible substrate instead of a glass substrate to reduce weight and ease installation. Flexible EL or T-OLED displays are particularly suitable for use with merchandisers having curved glass doors and viewing panels.

In some embodiments (not illustrated), the transparent electronic image display screen may be optically bonded to the outer surface of the transparent front panel of the merchandiser.

While the examples described herein are generally discussed in the context of refrigerated display case merchandisers in view of the recognized desirability of adapting a transmissive display to an existing refrigerated display case door without modifying or disturbing the integrity of the refrigerated environment, it will be appreciated that embodiments of the hardware and methods described herein may be employed with ambient environment display cases or non-refrigerated, controlled or uncontrolled environment display cases without departing from the scope of the present disclosure. For example, a transparent electronic image display screen may be used to attract passers-by to any suitable closed display case with vibrant graphic images, pique viewer interest in a product in the display case with teasing glimpses of the product, and then dramatically reveal the entire product.

It will be obvious to those having skill in the art that many changes may be made to the details of the above-described embodiments without departing from the underlying principles of the invention.

1. An electronic display apparatus for installation on a display case merchandiser having a door with a transparent front panel, comprising:
a bezel configured to attach to the outside of the door of the display case merchandiser so a portion of the transparent front panel of the door is viewable through an opening of the bezel;
a transparent electronic image display panel connected to the bezel, the display panel overlaying at least a portion of the bezel opening and overlaying a portion of the transparent front panel of the door when the electronic display apparatus is installed;
a light source connected to the bezel and arranged to fit in a gap formed between the bezel and the door when the electronic display apparatus is installed, the light source oriented to direct light through the transparent front panel and into a compartment of the merchandiser when the electronic display apparatus is installed.

2. The electronic display apparatus of claim 1, wherein the electronic image display panel includes a touch screen interface.

3. The electronic display apparatus of claim 1, wherein the light source generates a beam of light, and the light source is oriented on the bezel to direct a center of the beam toward the merchandiser at an angle between fifteen degrees and sixty degrees measured between a plane of the transparent front panel and the center of the beam, when the electronic display apparatus is installed.

4. The electronic display apparatus of claim 1, wherein the light source extends along a periphery of the opening of the bezel.

5. The electronic display apparatus of claim 4, wherein the light source comprises a plurality of light emitting diodes distributed along the periphery.

6. The electronic display apparatus of claim 4, further comprising a baffle attached to the bezel and disposed between the opening of the bezel and the light source to thereby occlude a direct view of the light source through the transparent electronic image display panel.

7. The electronic display apparatus of claim 1, wherein the light source extends around a periphery of the opening of the bezel.

8. The electronic display apparatus of claim 1, further comprising an optical diffuser attached to the bezel and disposed over the light source.

9. The electronic display apparatus of claim 8, wherein the optical diffuser is arranged to make optical contact with the transparent front panel of the door when the electronic display apparatus is installed.

10. The electronic display apparatus of claim 8, wherein the optical diffuser is elongate and extends at least partially around the light source to form a duct between the bezel and the optical diffuser.

11. The electronic display apparatus of claim 10, wherein the bezel includes an inner major surface and a flange portion, the inner major surface facing an outer face of the door when the electronic display apparatus is installed, the flange portion extending inwardly from the inner major surface and having a plurality of vent holes extending therethrough.

12. The electronic display apparatus of claim 1, wherein the bezel comprises a plurality of vent holes extending therethrough.

13. The electronic display apparatus of claim 1, further comprising:
a sensor for detecting a position of the door when the electronic display apparatus is installed; and
a controller configured to adjust the brightness of the light source when the sensor detects a change in the position of the door.

14. The electronic display apparatus of claim 1, wherein the transparent electronic image display panel is a vertical alignment active matrix liquid crystal display.

15. The electronic display apparatus of claim 1, wherein the transparent electronic image display panel includes a clear front polarizer layer and a clear rear polarizer layer.

16. A display case merchandiser, comprising:
a compartment having an opening;
a door movable between a closed position covering the opening and an open position allowing a user to reach through the opening to access the compartment, the door having a transparent front panel through which the compartment is visible from outside the merchandiser when the door is closed;
a transparent electronic image display panel attached to an outside of the door facing away from the compartment, the transparent electronic image display panel facing an outside face of the door and overlaying at least a portion of the transparent front panel;
a light source mounted to the outside of the door and oriented to direct light into the compartment through the transparent front panel such that the light is reflected out of the compartment and outwardly through the transparent electronic image display panel.

17. The display case merchandiser of claim 16, wherein the electronic image display panel includes a touch screen interface.

18. The display case merchandiser of claim 16, wherein the light source generates a beam of light, and the light source is oriented to direct a center of the beam toward the compartment at an angle between fifteen degrees and sixty degrees measured between the transparent front panel and the center of the beam.

19. The display case merchandiser of claim 16, wherein the light source extends along a periphery of the electronic image display panel.

20. The display case merchandiser of claim 16, wherein the light source comprises a plurality of light emitting diodes distributed along the periphery.

21. The display case merchandiser of claim 16, further comprising a baffle attached to the door and disposed between the electronic image display panel and the light source to thereby occlude a direct view of the light source through the transparent electronic image display panel.

22. The display case merchandiser of claim 16, further comprising an optical diffuser disposed over the light source.

23. The display case merchandiser of claim 22, wherein the optical diffuser is arranged to make optical contact with the transparent front panel of the door.

24. The display case merchandiser of claim 22, further comprising a bezel attached to the door and the electronic image display panel, and wherein the optical diffuser is elongate and extends at least partially around the light source to form a duct between the bezel and the optical diffuser.

25. The display case merchandiser of claim 24, wherein the bezel comprises a plurality of vent holes extending therethrough.

26. The display case merchandiser of claim 16, further comprising:
a sensor for detecting a position of the door; and
a controller configured to adjust the brightness of the light source when the sensor detects a change in the position of the door.

27. The display case merchandiser of claim 16, where the compartment includes an illuminated showcase region positioned behind the portion of the transparent front panel overlaid by the transparent electronic image display panel, and further comprising an opaque light partition forming a boundary of the illuminated showcase region to prevent light leakage from the illuminated showcase region to another portion of the compartment.

28. A method for illuminating a transparent electronic image display panel attached to an outside of a display case merchandiser, the merchandiser having a compartment viewable through a transparent panel overlaying at least a portion of the transparent electronic image display panel, comprising:
emitting light from a gap between the electronic image display panel and the outside of the compartment to thereby illuminate the compartment via light entering through the transparent panel and into the compartment;
reflecting light out of the compartment through the transparent front panel and the transparent electronic image display panel; and
modulating the reflected light via the transparent electronic image display panel.

29. The method of claim 28, further comprising adjusting the intensity of the emitted light based on a position of a door of the merchandiser.
